(19) United States
(12) Patent Application Publication
(10) Pub. No.: US 2004/0047308 A1
(43) Pub. Date: Mar. 11, 2004

(54) Secure signature in GPRS tunnelling protocol (GTP)

(76) Inventors: Alan Kavanagh, Westmount (CA); Mathieu Giguere, Pincourt (CA)

Correspondence Address: ALEX NICOLAESCU, Ericsson Canada Inc., Patent Department (LMC/M/P), 8400 Decarie Blvd., Town Mount Royal, QC, H4P 2N2, CA

(21) Appl. No.: 10/465,225

(22) Filed: Jun. 20, 2003

Related U.S. Application Data
(60) Provisional application No. 60/403,883, filed on Aug. 16, 2002.

(51) Int. Cl. H04Q 7/00

(52) U.S. Cl. 370/328; 370/465

(57) ABSTRACT

A method, system, transmitter and receiver for checking an integrity and authenticity of GPRS Tunnelling protocol (GTP) communications of a GPRS system, wherein for each GTP data packed to be sent, the GTP transmitter generates a sequence number indicative of the GTP data packet number, creates the GTP data packet, and computes a digest value associated to the GTP data packet using a shared secret key and information related to the GTP data packet, such as the entire GTP data packet, the IP packet that encapsulates the GTP data packet or NULL data. The GTP transmitter then sends the GTP data packet to a GTP receiver, which uses the shared secret key and the digest value of the GTP data packet to check the authenticity and integrity of the received data packet.

### PRIORITY STATEMENT UNDER 35 U.S.C. S.119(e) & C.F.R. S.1.78

This non-provisional patent application claims priority based upon the prior U.S. provisional patent application entitled “SECURE SIGNATURE IN GTP (SSG)”, application No. 60/403,883, filed Aug. 16, 2002, in the names of Alan KAVANAGH and Mathieu GIGUERE.

### BACKGROUND OF THE INVENTION

1. Field of the Invention

The present invention relates to secured communications, and particularly to a method and system for securing the authenticity and Integrity of communications based on the General Packet Radio Service (GPRS) Tunnelling Protocol (GTP).

2. Description of the Related Art

The General Packet Radio Service (GPRS) is a packet-based wireless communication service that allows data rates from 56 Kbps up to 172 Kbs and continuous connection to the Internet for mobile phone and computer users. The higher data rates allow users to take part in videoconferences and interact with multimedia Web sites and similar applications using mobile devices as well as notebook computers. GPRS is based on the Global System for Mobile (GSM) communications and complements existing services such as the circuit-switched cellular phone connections and the Short Message Service (SMS).

GPRS communication channels are operated on a shared-use, as-packets-are-needed basis, rather than being dedicated only to one user at a time. It is easier to make applications available to mobile users because the faster data rate means that middleware currently needed to adapt applications to the slower speed of wireless systems will no longer be needed. As GPRS becomes available, mobile users of a Virtual Private Network (VPN) are able to access the VPN continuously rather than through a dial-up connection.

GPRS also complements Bluetooth, a standard for replacing wired connections between devices with wireless radio connections. In addition to the Internet Protocol (IP), GPRS supports X.25, a packet-based protocol that is mainly used in Europe. GPRS is an evolutionary step toward the 3^{rd} Generation (3G) cellular systems such as the Enhanced Data for GSM Environment (EDGE) and the Universal Mobile Telephone Service (UMTS).

Typical GPRS networks contain two main network nodes. First, a Serving GPRS Support Node (SGSN) is a point of attachment for a Mobile Station (MS) to the Packet Data Network (PDN), and is responsible for the delivery of data packets from and to the MSs within its geographical service area. Its tasks include packet routing and transfer, mobility management (attach/detach and location management), logical link management, and authentication and charging functions. Second, a Gateway GPRS Support Node (GGSN), is the access server/gateway of the GPRS system to an external PDN, which may be a VPN or Internet Service Provider (ISP) network. The GGSN is responsible for session management within the mobile network, as well as for encapsulation and de-encapsulation of bearer traffic sent to and from the SGSN.

In GPRS, an MS is typically a combination of a Mobile Terminal (MT), which may be either a GPRS mobile phone and/or a GPRS PCMCIA card that has GPRS functionality, and a Terminal Equipment (TE), which can be a Laptop, PC, Personal Digital Assistant (PDA) or other terminal.

Reference is made to FIG. 1 (Prior Art) showing a nodal operation and signal flow diagram of a simplified GRPS network 100 implementing a PDP Context procedure of an MS 102 to an SGSN 104 via a Base Station Subsystem 103, for allowing the MS 102 to receive GPRS support from the SGSN 104. When the MS 102 attaches and registers to the GPRS network 100, it initiates an Activate PDP Context Request 106 and may specify an Access Point Name (APN), Quality of Service (QoS), and Protocol Configuration Options (PCO) etc. The SGSN 104 receives the APN and uses it to locate which GGSN 108 is connected to the external PDN (not shown) requested by the MS 102. With the help of a Domain Name Server (DNS, not shown), the SGSN 104 sends a DNS Request to the DNS Server to translates the APN into an IP address of the appropriate GGSN 108 connected to the external PDN requested by the MS 102 and returns the result to the SGSN in a DNS Response.

The SGSN 104 then initiates a Create PDP Context Request 110 to the GGSN 108, which is the first step in establishing a GPRS Tunnelling Protocol (GTP) tunnel between the SGSN 104 and the GGSN 108. The Create PDP Context Request 110 which is part of the GTP-Control plane signalling is sent from the SGSN 104 to the GGSN 108 (for both GTP version 0 and version 1) over User Datagram Protocol (UDP) for IP-based networks, or alternatively over the Transport Control Protocol (TCP) for X.25 based networks. The GGSN 108 responds with a message Create PDP Context Response 112 to the SGSN 104, the message 112 comprising a cause value Request Accepted. A GTP Tunnel 114 is now established for the MS 102 between the SGSN 104 and GGSN 108. Finally, the SGSN 104 sends an Activate PDP Context Accept 116 to the MS 102 confirming if the active PDP Context has been accepted or rejected establishment of the GTP tunnel 114. In GTP version 0, the GTP tunnel is created between the SGSN 104 and the GGSN 108, as shown in FIG. 1 for both the GTP user plane and the GTP control plane, but the GTP user plane tunnel may also extend to the Radio Network Controller (RNC) of the BSS 103 in GTP version 1.

Likewise, a different GTP tunnel alike the GTP tunnel 114 is established for every PDP Context of an MS that is granted access to the GPRS network and/or to the requested external service.

The GTP Tunnel 114 can be torn down either by the operator, or as in FIG. 2 (Prior Art), which is a nodal operation and signal flow diagram of a simplified GRPS network 200 implementing an MS-initiated GPRS detach procedure of the MS 202 from an SGSN 204 via a BSS 203. The MS 202 initiates a Detach Request 204 to the SGSN 206, which in turn sends a GTP signalling request message Delete PDP Context Request 208 to the GGSN 210 in the GTP Control Plane. The GGSN 210 deletes the PDP Context for the MS 202 and responds with a GTP signalling message Delete PDP Context Response 212 to the SGSN 206, which also deletes the PDP Context and, as a result, the GTP tunnel 114 is torn down. The MSC 220 is also updated via an International Mobile Subscriber Identity (IMSI) Detach message 222 and a GPRS Detach message 224. Confirmation of the deletion of the GTP tunnel 114 is also sent to the MS 202 via a Detach Accept message 226.

In GPRS systems, GTP Tunnels alike the GTP tunnel 114 are established over two GPRS interfaces between cooperating GPRS Service Nodes (GSNs): first, over the Gn interface, which connects the GSN nodes in the operator's own Public Local Mobile Network (PLMN) and, second, over the Gp interface which is used to connect GSN nodes in different PLMN networks.

Reference is now made to FIG. 3 (Prior Art), which is a high-level network reference diagram of a GPRS/Universal Mobile Telephone Service (GPRS/UMTS) network 300. FIG. 3 shows the two GPRS/UMTS interfaces between cooperating GSNs where the GTP tunnels may be established: first, GTP tunnels can be established over the Gn interface 302 that connects the SGSN and GGSN nodes 104, 104′, 108 of the same PLMN 300; second, the Gp interface 304 can also connect the GGSN 108 and SGSN 104″ of different networks 100 and 100′. It is to be noted that in GTP version 1, the GTP tunnels for the user plane can also be established over the lu interface for GTP User Plane connecting the SGSNs 104 and 104″ to the Radio Network Controller (RNC) 103. FIG. 3 also shows the BSS 103 and its equivalent in a Universal Mobile Telecommunications System (UMTS) based system, the UTRAN 103′, and the MSs 102 and 102′.

Based on the type of messages that are carried, GTP tunnels are divided into two signalling planes, the control and user planes. The GTP control plane is the signalling plane used to establish a GTP Tunnel between the nodes of the GPRS/UMTS network, to tear down the tunnel when transmission is finished, maintain the state of the GTP connection, handle GTP connection updates when the MS roams from one SGSN to another SGSN, etc. GTP control plane is typically applicable to the following message types: path management, tunnel management, location management and mobility management messages.

All the GPRS/UMTS packet data traffic/payload sent and received from the MS to the external PDN, Corporate Access or Application Service Provider (ASP) is encapsulated in GTP packets between the SGSN, GGSN and RNC nodes and is called GTP user plane. The GTP user plane is used only between the GSN nodes in GTP version 0, in order to encapsulate the MS Packet Data Units (PDUs) transmitted to and from the external network. In GTP Version 1, the GTP user plane is also extended to the Radio Network Controller (RNC) of the UTRAN so that the MS's PDU's are encapsulated in GTP between the RNC, SGSN and GGSN nodes in a UMTS network, for example.

IP-based telecommunication networks, including the GPRS/UMTS network, were built on a trusted-based model. However, it has been realized that it is a common misconception to assume that all networks can always be trusted. Rather, it is determined that a good rule of thumb in network security is that once a private or public network peers with another network, or if any portion of a network carrier is leased from another operator, security, authenticity and integrity should not be taken for granted. For example, because GTP is used to connect GSN nodes between home and visited PLMNs, a GPRS/UMTS PLMN operator is at the mercy of his neighbouring operator(s) to ensure security, integrity and authenticity in their network, and for preventing malicious attacks on legitimate GTP connections.

Currently, there is no integrated authenticity and integrity checking mechanisms into the GTP Protocol, and thus GTP communications are exposed to different types of security attacks. Since GTP is an IP-based communication protocol, the peer node is trusted based on its IP address and port number. However, this leaves GTP exposed to a variety of security attacks, such as for example to PDP context spoofing, GTP tunnel/session hijacking, GTP replay attacks, GTP malicious attacks and GTP denial of service attack.

PDP Context Spoofing occurs when the attacker impersonates an MS by selecting vital fields in the GTP control plane message during session setup to fraudulently establish a PDP Context with a GSN node and gain access to the MS user services in the network. This may be achieved by capturing the transmitted GTP control plane packets and replaying the message to the designated GSN nodes in order to gain access to the network. This type of attack is typically used to gain access to the external PDN or specific services of the MS by masquerading.

Tunnel Hijacking occurs once a legitimate MS has successfully established a PDP context and when a hacker steals the session on the Gn/Gp interface. This is applicable when the MS is in the Home PLMN network or in a visited PLMN network, and its purpose is to gain access to the external PDN or specific services provided to the MS.

Replay attacks occur when a hacker connects on the wire and captures GTP packets in the control and user plane and replays them to cause a Denial of Service (DoS) type of attack on the GSN nodes. This method may also be used for session hijacking, where legitimate GTP control plane messages are captured, and then replayed. This type of attack is typically used to disrupt the flow of packets to the GSN nodes and MS user.

Other types of GTP malicious attacks can occur in numerous forms and for various reasons. The attacks may be used to disrupt the flow of GTP traffic and cause MS users to be deactivated from the mobile network or attempt or block the MS user from receiving data from the external PDN by blocking GTP traffic. Among these, the DoS attacks are not used to gain access to the systems, but rather to disrupt GSN nodes from performing legitimate requests and cause some GTP messages to be dropped or retransmitted, wherein the hacker sends large amounts of GTP Control or User Plane data with the purpose of disrupting normal service of the GSN nodes.

A partial solution to the noted GTP security problems was to use a security mechanism called IPSec. However, IPSec does not guarantee that GTP is secured from end to end. Instead IPSec is typically run from the edge of a network from a POP-to-POP deployment architecture and/or hop-by-hop security. For example, IPSec can be run from GSN to GSN node in a peer to peer network or from hop-to-hop using a hub and spoke implementation where IPSec is run from an SGSN to a Security Gateway (SG) to SGSN, and SGSN to SG to GGSN, which alleviates the problem of having to run IPSec from peer-to-peer for each GSN node resulting in a mesh-based architecture. This arrangement is cumbersome to manage and difficult to scale. This implementation leaves the network susceptible to attacks because it trusts all traffic incoming and outgoing in the IPSec tunnel, which cannot be guarantied as legitimate and compromising the SG leaves all nodes connected to the Hub (SG) susceptible to attacks.

There is therefore a need for an increased level of security suitable to all GTP communications of a given network, and applicable both to the GTP user plane and to the GTP control plane. Particularly, there is a need for a mechanism insuring authenticity of the GTP data packets exchanged in a GRPS/UMTS packet data network. The present invention provides such a solution.

### SUMMARY OF THE INVENTION

In one aspect, the present invention is a method for packet data transmission in a General Packet Radio Service/Universal Mobile Telephone System (GPRS/UMTS) system using GPRS Tunnelling Protocol (GTP), the method comprising:

during a GTP communication between a GTP transmitter and GTP receiver, sending from the GTP transmitter to the GTP receiver a GTP data packet with:

a sequence number indicative of a number of the GTP data packet;

a digest value computed by the GTP transmitter using a shared secret key and information related the GTP data packet;

transmitting the GTP data packet from the GTP transmitter to the GTP receiver; and

verifying by the GTP receiver at least one of an authenticity and an integrity of the GTP data packet using the sequence number and the digest value contained in the GTP data packet.

In another aspect, the invention is a General Packet Radio Service/Universal Mobile Telephone System (GPRS/UMTS) system using GPRS Tunnelling Protocol (GTP), comprising:

a GTP transmitter capable of carrying out GTP communications; and

a GTP receiver capable of carrying out GTP communications;

wherein when the GTP transmitter and the GTP receiver are carrying out a GTP communication, the GTP transmitter generates a GTP data packet with i) a sequence number indicative of a number of the GTP data packet and ii) a digest value computed by the GTP transmitter using a shared secret key and information related the GTP data packet, and transmits the GTP data to the GTP receiver, which upon receipt of the GTP data packet verifies an authenticity and integrity of the GTP data packet using the sequence number and the digest value contained in the GTP data packet.

In yet another aspect, the invention is a General Packet Radio Service/Universal Mobile Telephone System (GPRS/UMTS) Tunnelling Protocol (GTP) transmitter comprising:

a memory for storing a shared secret key;

wherein when the GTP transmitter carries out a GTP communication with a GTP receiver, the GTP transmitter generates a GTP data packet with i) a sequence number indicative of a number of the GTP data packet, and ii) a digest value computed by the GTP transmitter using the shared secret key and information related the GTP data packet; and transmits the GTP data packet to the GTP receiver.

In yet another aspect, the invention is a General Packet Radio Service/Universal Mobile Telephone System (GPRS/UMTS) Tunnelling Protocol (GTP) receiver, comprising:

a memory for storing a shared secret key;

wherein when the GTP receiver carries out a GTP communication with a GTP transmitter, the GTP receiver receives from the GTP transmitter a GTP data packet with i) a sequence number indicative of a number of the GTP data packet and ii) a digest value computed by the GTP transmitter using a shared secret key and information related the GTP data packet, wherein upon receipt of the GTP data packet, the GTP receiver verifies an authenticity and an integrity of the GTP data packet using the sequence number and the digest value contained in the GTP data packet.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a nodal operation and signal flow diagram of a simplified GPRS network illustrative of a mobile station GPRS attach operation;

FIG. 2 (Prior Art) is a nodal operation and signal flow diagram of a simplified GPRS network illustrative of a mobile station GPRS detach operation;

FIG. 3 (Prior Art) is a high-level network reference diagram illustrative of an exemplary GPRS/UMTS network including the Gn and Gp interfaces carrying GTP messages;

FIG. 4 is an exemplary illustration of a GTP version 0 data packet according to the preferred embodiment of the present invention;

FIG. 5 is an exemplary illustration of a GTP version 1 data packet according to the preferred embodiment of the present invention;

FIG. 6 is an exemplary illustration of a field of the GTP data packet according to the preferred embodiment of the present invention;

FIG. 7 is an exemplary illustration of an application of a digest algorithm according to the preferred embodiment of the present invention; and

FIG. 8 is an exemplary nodal operation and signal flow diagram of a simplified GPRS network implementing the preferred embodiment of the present invention.

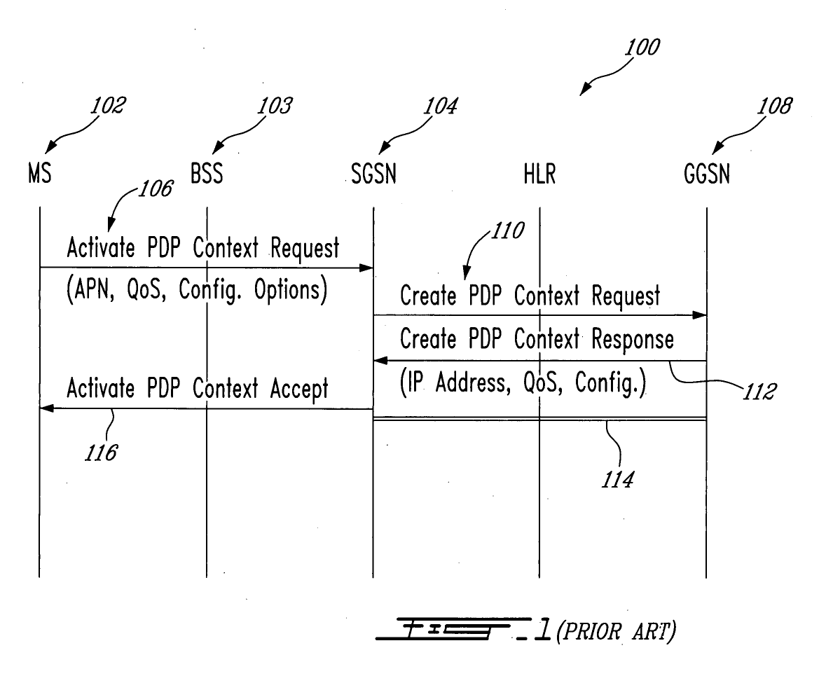

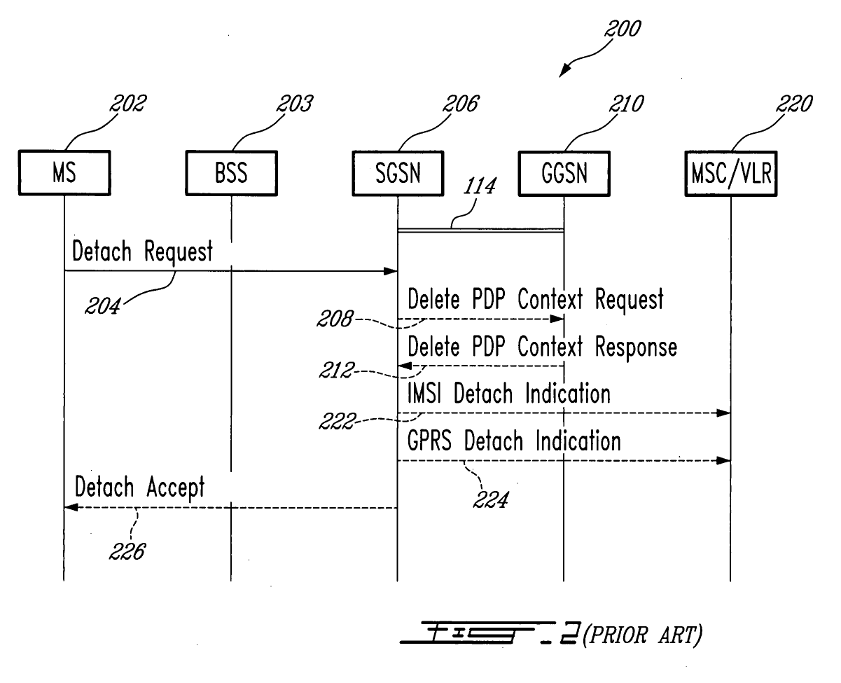

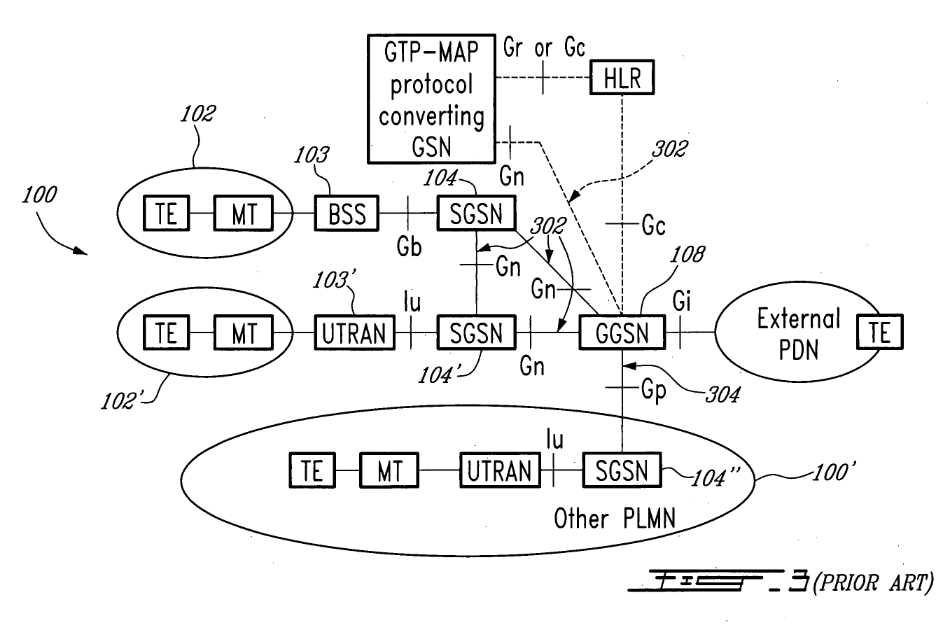

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention solves the above-mentioned deficiencies by providing a mechanism that guarantees the authenticity and Integrity of GTP communications. With the present invention, each GTP data packet exchanged during a GTP communication between a GTP sender and a GTP receiver is added information, also called herein a secure signature, allowing the GTP receiver to verify the authenticity and Integrity of that data packet. In this manner, all the GTP data packets exchanged over a GTP connection between a GTP sender and a GTP receiver are authenticated and their integrity is checked, so that their validity is verified, thus avoiding the aforementioned prior art deficiencies.

According to the present invention, the secure signature is created by the GTP sender and included in each GTP packet sent from a GTP sender to a GTP receiver in both the control plane and the user plane, and includes first, a sequence number indicative of the data packet number and second, a calculated digest value, computed based on i) a shared secret key and ii) a series of data of the GTP packet itself.

The sequence number may be used to provide a mechanism to prevent replay attacks only as the ones described hereinbefore, for data packets that are maliciously captured on the wire and possibly replayed. The sequence number provided by the present invention is incremented for each consecutive data packet being transmitted by the GTP sender so that when a malicious replay attack occurs, the receiver can detect that the received data packets stop to increment as expected, which provides indication to the GTP receiver that a replay attack is being carried out.

The digest value may be, for example, a valued computed using an algorithm such as SHA-1, SHA 256 and HMAC-MD5 digest, as it is disclosed in the book Demystifying the IPsec Puzzle, by Sheila Frankel, published by the Artech House in the Computer Security Series, in year 2001, herein included by reference. The digest value is used to provide integrity and authenticity for GTP packets. Since the digest value is calculated using a shared secret key that is previously securely distributed among GTP senders and receivers of a given GPRS/UMTS network this shared secret can be used to recalculate the digest and compare the result with the digest value sent at the end of the packet. The present mechanism can be used to verify the authenticity and Integrity of the content of each received GTP data packet. Doing so prevents attacks such as tunnel hijacking, PDP context spoofing, malicious attacks and replay attacks.

Reference is now made to FIG. 4, which is an exemplary illustration of a GTP version 0 data packet 400 according to the preferred embodiment of the present invention. The data packet 400 includes the secured signature provided by the present invention. The GTP data packet 400 comprises a GTP header 402 including information related to the GTP version being used, to the type of GTP message, to the length of the GTP message, etc. The GTP data packet 400 further comprises a plurality of information elements 404ᵢ. Finally, according to the present invention, the GTP data packet 400 may comprise a Private Extension Information Element (PEIE) 406₁ including a sequence number provided by the present invention as part of the secure signature. The GTP data packet 400 further comprises a PEIE 406₂ with a reference to the type and length of a digest value 407, which is also part of the secure signature, and which may be appended at the end of the GTP data packet 400. The private extension information element 406₁ will be further discussed in greater details

FIG. 5 is an exemplary illustration of a GTP version 1 data packet 500 according to the preferred embodiment of the present invention, which data packet includes the secured signature provided by the present invention. The GTP data packet 500 comprises a GTP header 502 including information such as the version of the GTP protocol being used, an extension header flag, a message type, a length of the GTP data packet, etc. The GTP data packet 500 further comprises a plurality of information elements 504i. According to the present invention, one of the information elements 504, preferably the first data field following the GTP header 502, may comprise a GTP header extension 504₁ including the sequence number provided by the present invention. The data packet 500 may further comprise a second GTP extension header 504₂ with a reference to the type and length of a digest value 506, which may be appended at the end of the GTP data packet 500. The length and type information of the GTP extension header 504₂ allows the receiver of the GTP data packet 500 to decode the accompanied digest value 506. The private extension information element 504ᵢ will also be further discussed in greater details.

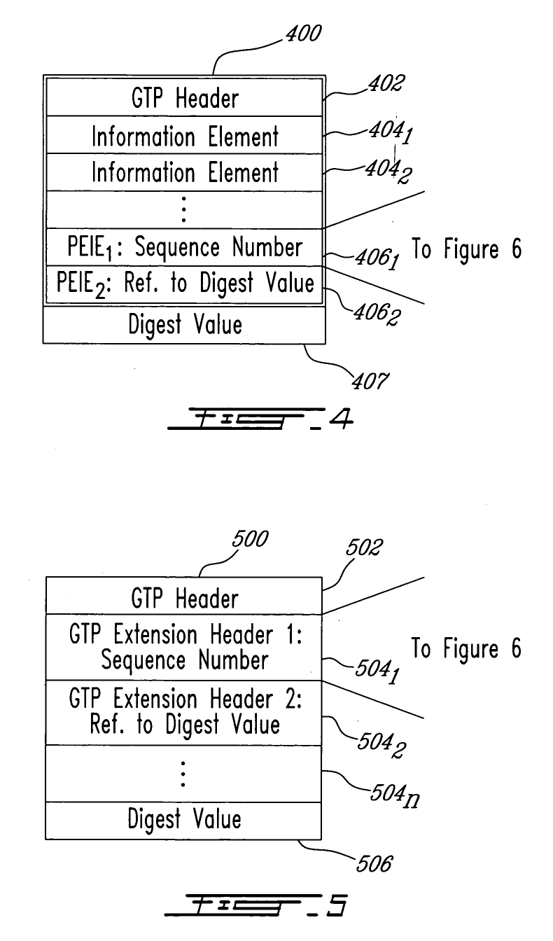

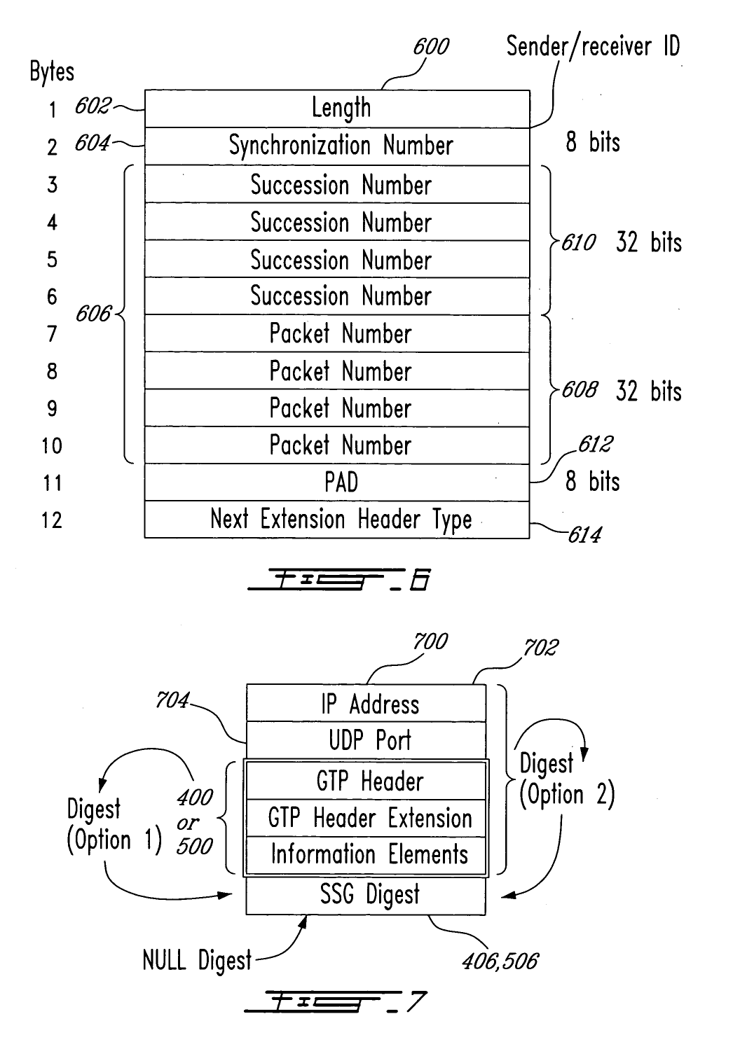

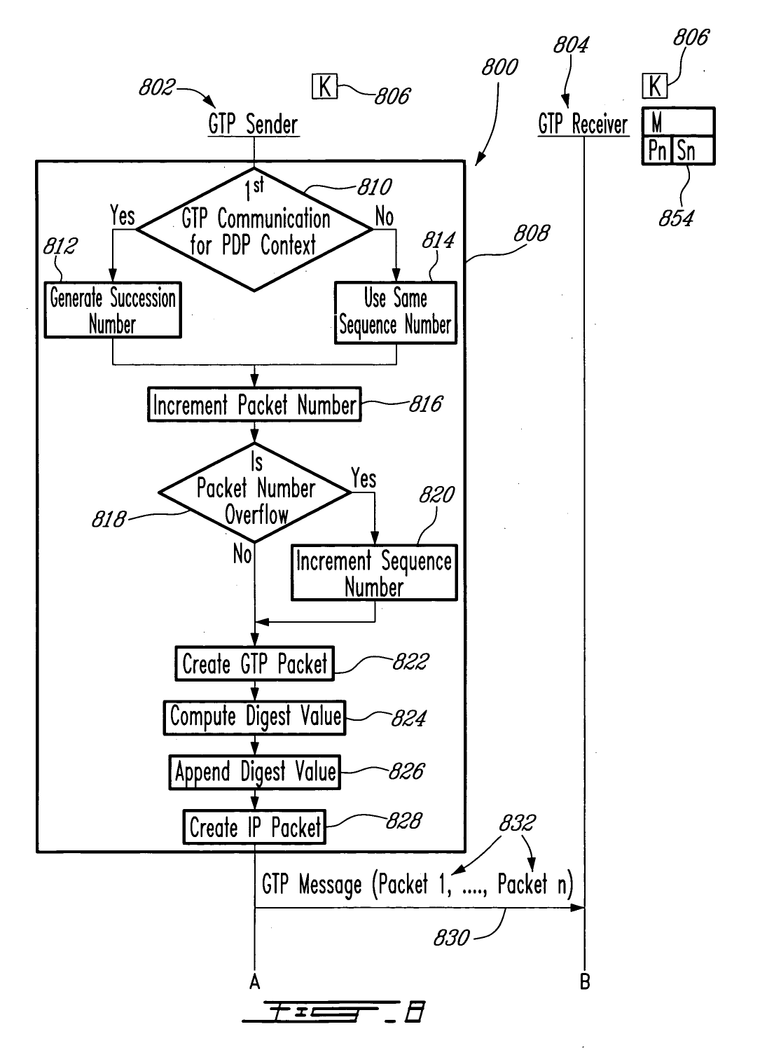

FIG. 6 is an exemplary illustration of a private extension information element field 406₁, or of a GTP header extension field 504₁, of the GTP data packet 400 or 500 respectively, according to the preferred embodiment of the present invention. The data field 600 comprises a synchronization number 604 that includes identification information related to the sender and the receiver of the GTP data packet 400 or 500. The data field 600 further comprises a sequence number 606 that may be 8-byte long, which is a value that is always incremented by the GTP sender between consecutive GTP data packets of the same type (control and user plane are independently incremented). The sequence number 606 first comprises a packet number value 608 that may be 4-byte long, which identifies the number of a packet and is incremented between each consecutive data packets sent by a GTP sender. Preferably, the packet number value has a range from 1 to 2³², since it is comprises in 4 bytes of data. The sequence number 606 further comprises a succession number value 610 that may also by 4-byte long and that is incremented only when the packet number value reaches 2³². In this manner, the sequence number 606 comprising the packet number value 608 and is the succession number 610 provides a reliable indication on the actual GTP packet number being transmitted.

According to a variant of the preferred embodiment of the present invention, the succession number 610 can be replaced by a timestamp indicative of the precise time when the GTP sender has sent the GTP data packet, preferably based upon the Network Timing Protocol.

Finally, the data field 600 comprises a PAD portion 612 specifying the Extension Header Length field with information about the length of the particular Extension header in 4 octets units. The data field 600 further comprises a field 614 with information about the next extension header type that specifies the type of any Extension Header that may follow a particular Extension Header. If no such Header follows, then the value of the Next Extension Header Type shall be 0.

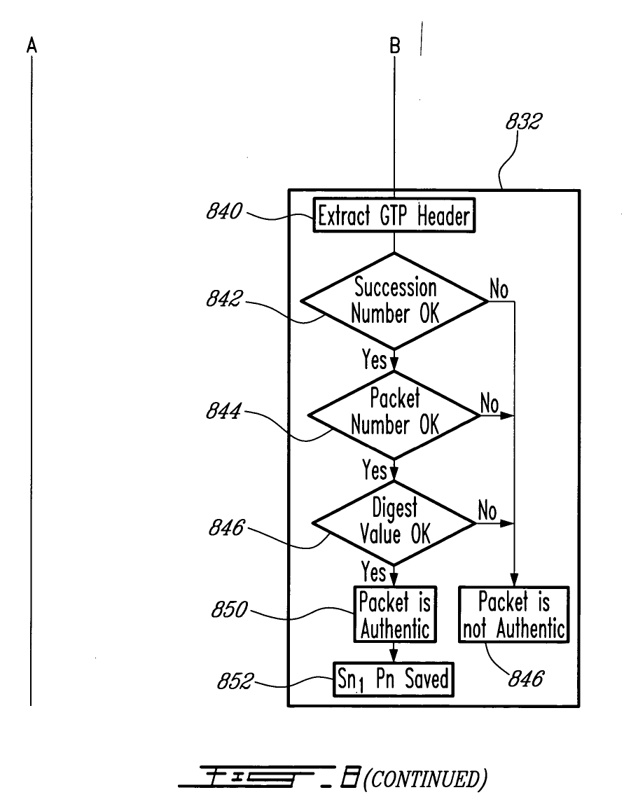

FIG. 7 is an exemplary illustration of an application of the digest algorithm according to the preferred embodiment of the present invention. In order to secure each GTP data communication that is being performed in the network, the present invention appends a digest value to each GTP data packet that is exchanged between the GTP sender and the GTP receiver. FIG. 7 illustrates an IP data packet 700 including a GTP data packet 400 or 500, which may be exchanged during a GTP communication between a GTP transmitter and a GTP receiver. The IP data packet 700 comprises an IP address 702, a UDP port 704, and a GTP data packet 400/500.

According to a first option of the present invention shown in FIG. 7, the digest value 406 or 506 can be calculated by the GTP transmitter using a shared secret key and data of the entire GTP data packet 400 or 500, and its value appended at the end of the GTP data packet 400 or 500, within the IP data packet 700.

According to a second option of the present invention shown in FIG. 7, the digest value 406 or 506 can be calculated by the GTP transmitter using a secret key and data of the entire IP data packet 700, and its value appended at the end of the IP data packet 700.

According to a third option of the present invention, the digest value 407 or 506 can be a NULL digest value with a length of 0, so that no calculation is required for the digest in both sender and receiver, and its value can be appended at the end of the GTP data packet 400 or 500, within the IP data packet 700.

Reference is now made to FIG. 8, which is an exemplary nodal operation and signal flow diagram of a simplified GPRS/UMTS network 800 implementing the preferred embodiment of the present invention. Shown in FIG. 8 is a GTP sender 802 and the GTP receiver 804 that are assumed to be able to carry GTP communications both in the control plane and the user plane. It is also assumed in the present scenario that a secret key 806 used for securing GTP communications in the network 800 was previously securely distributed to the nodes of the network 800, including to the GTP sender 802 and to the GTP receiver 804. With reference to FIG. 8, when the GTP sender 802 is to send a GTP data packet to the GTP receiver 804, first the GTP sender 802 creates the GTP data packet containing the secure signature, action 808. For this purpose, the GTP sender 802 first detects if the GTP communication including the GTP packet under construction is the first GTP communication for the PDP context/Mobile Station associated to that communication, action 810. If so, this means that no succession number 610 is yet created, and therefore in action 812 the GTP sender 802 generates a new succession number 610. If in action 810 it is rather detected that it is not the first communication associated to that PDP context/Mobile Station, then the GTP sender 802 decides to use the same sequence number as before, action 814. Because the GTP data packet is a new packet, in action 816, the GTP sender 802 increments the packet number 608, and in action 818 may detects if the packet number 610 is overflow, i.e. greater than 2³² and if so, increments the succession number 610, action 820. In action 822, the GTP sender 802 creates the GTP data packet 400 or 500 using the succession number 610, the packet number 608 and data payload load that is to be carried by the GTP data packet 400 or 500, as described in relation to FIGS. 4, 5, and 6 and 7. In action 824, the GTP sender 802 creates the digest value 406 or 506 using one of the three options described in relation to FIG. 7. In action 826, the GTP sender 802 appends the digest value 406 or 506 to the GTP data packet, and in action 828 the IP data packet 700 is created. In action 830, a GTP message is transmitted to the GTP receiver 804 including a plurality of IP data packets 832.

The GTP receiver 804 receives the GTP message 830 and in action 832 it validates the received GTP data packets like the packets 400/500 using the secure signature comprising the sequence number 606 and the digest value 406/506. For this purpose first, the GTP receiver 804 extracts the GTP data packets from the IP packets and for each GTP data packet first extracts the GTP header 402/502, action 840. Possibly using information extracted from the GTP header, the GTP receiver 804 locates the sequence number information of the GTP data packet, and in action 842 detects if the succession number 610 is valid by comparing it with the previously received data packet's succession number. The succession number 610 is considered to be valid if it is the same as the previously received succession number or if it is incremented by one. If the succession number is detected as being valid in action 842, the GTP receiver 804 moves to action 844 where it is detected if the packet number is valid by comparing it with the previously received data packet's packet number. The packet number 608 is considered to be valid only if it is the immediate instrumentation number with respect to the previously received packet number, or if it equal to 1 and that the sequence number was incremented by one. If the packet number is also detected as being valid in action 844, the GTP receiver 804 moves to action 846 where it is detected if the digest value extracted from the GTP data packet is valid. For this purpose, the GTP receiver 804 uses the shared secret key 806 to recalculate the digest algorithm performed by the GTP sender 802 in action 824, and then performs a comparison action between the result of the recalculated digest and the digest appended at the received GTP packet. If the result is positive, then in action 850 it is concluded that the GTP data packet that is being analyzed is authentic and valid, and in action 852 the succession number 610, the packet number 608 are saved in a memory 854 of the GTP receiver 804, in order to be used for the next GTP data packet authentication. Otherwise, if any of the action 842, 844, and 846 provides negative result, it is rather concluded that the GTP data packet being analyzed is not authentic, and that it is likely that a malicious attack occurred during the GTP message transmission 830.

With the present invention it becomes possible to authenticate GTP data packets being transmitted in both a control plane and the user plane between a GTP sender 802 and the GTP receiver 804. It is to be noted that the GTP sender and the GTP receiver can be any type of nodes capable of caring GTP data communications including but a being not limited to an SGSN, a GGSN and an RNC. Also, during the same data communication a given node can act as both the GTP sender and the GTP receiver.

Based upon the foregoing, it should now be apparent to those of ordinary skills in the art that the present invention provides an advantageous solution, which offers easy and efficient data authentication, integrity and anti-replay attack protection for GTP control plane and/or GTP user plane for preventing malicious attacks on GTP data communications. Although the system and method of the present invention have been described in particular reference to certain radio telecommunications messaging standards (for example, GPRS, UMTS), it should be realized upon reference hereto that the innovative teachings contained herein are not necessarily limited thereto and may be implemented advantageously with any applicable radio telecommunications standard. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for packet data transmission in a General Packet Radio Service/Universal Mobile Telephone System (GPRS/UMTS) system using GPRS Tunnelling Protocol (GTP), the method comprising:
a) during a GTP communication between a GTP transmitter and GTP receiver, sending from the GTP transmitter to the GTP receiver a GTP data packet with:
a sequence number indicative of a number of the GTP data packet;
a digest value computed by the GTP transmitter using a shared secret key and information related the GTP data packet;
b) transmitting the GTP data packet from the GTP transmitter to the GTP receiver; and
c) verifying by the GTP receiver at least one of an authenticity and an integrity of the GTP data packet using the sequence number and the digest value contained in the GTP data packet.

2. The method claimed in claim 1 further comprising, prior to step a), the steps of:
at the GTP transmitter,
d) generating the sequence number indicative of the number of the GTP data packet used for the GTP communication; and
e) creating the GTP data packet comprising the sequence number;
f) computing the digest value using a shared secret key and information from the GTP data packet.

3. The method claimed in claim 2, wherein the GTP data packet is one of a plurality of GTP data packets transmitted during the data communication between the GTP transmitter and the GTP receiver, and wherein when generating the GTP data packet, the GTP transmitter increments the sequence number for every consecutive GTP data packet of the plurality of GTP data packets.

4. The method of claim 1, wherein step b) comprises transmitting the GTP data packet encapsulated into an IP data packet.

5. The method claimed in claim 1, wherein step c) comprises the steps of:
at the GTP receiver,
c.1) verifying the sequence number of the GTP data packet;
c.2) verifying the digest value received along with the GTP data packet;

6. The method claimed in claim 5, further comprising the step of:
c.3) concluding that the GTP data packet is authentic if both the sequence number and the digest value are successfully verified.

7. The method claimed in claim 5, further comprising the step of:
c.3) concluding that the GTP data packet is not authentic if any one or more of the sequence number and the digest value are unsuccessfully verified.

8. The method claimed in claim 1, wherein the GTP data packet comprises a Private Extension Information Element (PEIE) containing the sequence number, and wherein the digest value is appended to the GTP data packet.

9. The method claimed in claim 1, wherein the GTP data packet comprises a GTP extension header containing the sequence number, and wherein the digest value is appended to the GTP data packet.

10. The method claimed in claim 1, wherein the information related to the GTP packet data that is used to compute the digest value comprises the entire GTP data packet.

11. The method claimed in claim 4, wherein the information related to the GTP packet data that is used to compute the digest value comprises the IP data packet.

12. A General Packet Radio Service/Universal Mobile Telephone System (GPRS/UMTS) system using GPRS Tunnelling Protocol (GTP), comprising:
a GTP transmitter capable of carrying out GTP communications; and
a GTP receiver capable of carrying out GTP communications;
wherein when the GTP transmitter and the GTP receiver are carrying out a GTP communication, the GTP transmitter generates a GTP data packet with i) a sequence number indicative of a number of the GTP data packet and ii) a digest value computed by the GTP transmitter using a shared secret key and information related the GTP data packet, and transmits the GTP data to the GTP receiver, which upon receipt of the GTP data packet verifies an authenticity and integrity of the GTP data packet using the sequence number and the digest value contained in the GTP data packet.

13. The system claimed in claim 12 wherein the GTP transmitter generates the sequence number indicative of the number of the GTP data packet used for the GTP communication, creates the GTP data packet comprising the sequence number, and computes the digest value using a shared secret key and information from the GTP data packet.

14. The system claimed in claim 13, wherein the GTP data packet is one of a plurality of GTP data packets transmitted during the data communication between the GTP transmitter and the GTP receiver, and wherein when generating the GTP data packet, the GTP transmitter increments the sequence number for each consecutive GTP data packet of the plurality of GTP data packets.

15. The system claimed in claim 12, wherein the GTP transmitter transmits the GTP data packet encapsulated into an IP data packet.

16. The system claimed in claim 12, wherein the GTP receiver verifies the sequence number of the GTP data packet and further verifies the digest value received along with the GTP data packet.

17. The system claimed in claim 16, wherein the GTP receiver concludes that the GTP data packet is authentic if both the sequence number and the digest value are successfully verified.

18. The system claimed in claim 16, wherein the GTP receiver concludes that the GTP data packet is not authentic if any one or more of the sequence number and the digest value are unsuccessfully verified.

19. The system claimed in claim 12, wherein the GTP data packet comprises a Private Extension Information Element (PEIE) containing the sequence number, and wherein the digest value is appended to the GTP data packet.

20. The system claimed in claim 12, wherein the GTP data packet comprises a GTP extension header containing the sequence number, and wherein the digest value is appended to the GTP data packet.

21. The system claimed in claim 12, wherein the information related to the GTP packet data that is used to compute the digest value comprises the entire GTP data packet.

22. The system claimed in claim 15, wherein the information related to the GTP packet data that is used to compute the digest value comprises the IP data packet.

23. A General Packet Radio Service/Universal Mobile Telephone System (GPRS/UMTS) Tunnelling Protocol (GTP) transmitter comprising:
a memory for storing a shared secret key;
wherein when the GTP transmitter carries out a GTP communication with a GTP receiver, the GTP transmitter generates a GTP data packet with i) a sequence number indicative of a number of the GTP data packet, and ii) a digest value computed by the GTP transmitter using the shared secret key and information related the GTP data packet; and transmits the GTP data packet to the GTP receiver.

24. The GTP transmitter claimed in claim 23 wherein the GTP transmitter generates the sequence number indicative of the number of the GTP data packet used for the GTP communication, creates the GTP data packet comprising the sequence number, and computes the digest value using a shared secret key and information from the GTP data packet.

25. The GTP transmitter claimed in claim 24, wherein the GTP data packet is one of a plurality of GTP data packets transmitted during the data communication between the GTP transmitter and the GTP receiver, and wherein when generating the GTP data packet, the GTP transmitter increments the sequence number for every consecutive GTP data packet of the plurality of GTP data packets.

26. The GTP transmitter claimed in claim 23, wherein the GTP transmitter transmits the GTP data packet encapsulated into an IP data packet.

27. The GTP transmitter claimed in claim 23, wherein the GTP data packet comprises a Private Extension Information Element (PEIE) containing the sequence number, and wherein the digest value is appended by the GTP transmitter to the GTP data packet.

28. The GTP transmitter claimed in claim 23, wherein the GTP data packet comprises a GTP extension header containing the sequence number, and wherein the digest value is appended to the GTP data packet.

29. The GTP transmitter claimed in claim 23, wherein the information related to the GTP packet data that is used to compute the digest value comprises the entire GTP data packet.

30. The GTP transmitter claimed in claim 23, wherein the information related to the GTP packet data that is used to compute the digest value comprises the IP data packet.

31. A General Packet Radio Service/Universal Mobile Telephone System (GPRS/UMTS) Tunnelling Protocol (GTP) receiver, comprising:
a memory for storing a shared secret key;
wherein when the GTP receiver carries out a GTP communication with a GTP transmitter, the GTP receiver receives from the GTP transmitter a GTP data packet with i) a sequence number indicative of a number of the GTP data packet and ii) a digest value computed by the GTP transmitter using a shared secret key and information related the GTP data packet, wherein upon receipt of the GTP data packet, the GTP receiver verifies an authenticity and an integrity of the GTP data packet using the sequence number and the digest value contained in the GTP data packet.

32. The GTP receiver claimed in claim 31, wherein the GTP receiver receives the GTP data packet encapsulated into an IP data packet.

33. The GTP receiver claimed in claim 31, wherein the GTP receiver verifies the sequence number of the GTP data packet and further verifies the digest value received along with the GTP data packet.

34. The GTP receiver claimed in claim 33, wherein the GTP receiver concludes that the GTP data packet is authentic if both the sequence number and the digest value are successfully verified.

35. The GTP receiver claimed in claim 33, wherein the GTP receiver concludes that the GTP data packet is not authentic if any one or more of the sequence number and the digest value are unsuccessfully verified.

36. The GTP receiver claimed in claim 31, wherein the GTP data packet comprises a Private Extension Information Element (PEIE) containing the sequence number, and wherein the digest value is appended to the GTP data packet.

37. The GTP receiver claimed in claim 31, wherein the GTP data packet comprises a GTP extension header containing the sequence number, and wherein the digest value is appended to the GTP data packet.

38. The GTP receiver claimed in claim 31, wherein the information related to the GTP packet data that is used to compute the digest value comprises the entire GTP data packet.

39. The GTP receiver claimed in claim 31, wherein the information related to the GTP packet data that is used to compute the digest value comprises the IP data packet.
